(19) United States
(12) Patent Application Publication
(10) Pub. No.: US 2008/0007453 A1
(43) Pub. Date: Jan. 10, 2008

(54) Smart antenna array over fiber

(76) Inventors: Bill Vassilakis, Orange, CA (US); Matthew J. Hunton, Liberty Lake, WA (US); Alexander Rabinovich, Cypress, CA (US)

Correspondence Address: MYERS DAWES ANDRAS & SHERMAN, LLP, 19900 MACARTHUR BLVD.,, SUITE 1150, IRVINE, CA, 92612, US

(21) Appl. No.: 11/810,840

(22) Filed: Jun. 7, 2007

Related U.S. Application Data
(60) Provisional application No. 60/812,820, filed on Jun. 12, 2006.

(51) Int. Cl. H01Q 3/00; H04Q 7/20

(52) U.S. Cl. 342/368; 455/424

(57) ABSTRACT

A smart antenna system includes a plurality of antennas, a plurality of Transmit—Receive Modules (TRMs) coupled respectively to the plurality of antennas, and a beam steering module coupled to the plurality of TRMs and providing radiation beam steering for the plurality of TRMs. The beam steering module includes a pilot generator for generating a pilot signal and providing it to the TRMs to calibrate a receive (RX) reference plane. The pilot signal is injected at a first location before the receiver section into the RX path, and the pilot signal is sampled at a second location after the receiver section. The TRMs and the beam steering module can also be used to calibrate a transmit (TX) reference plane by sampling output signals from the TRMs. The output signals have a pilot signal component, and are sampled at the first location in the TX path after the transmitter section.

### CROSS-REFERENCE TO RELATED APPLICATION

The present application claims priority under 35 USC section 119(e) to U.S. Provisional Patent Application Ser. No. 60/812,820, filed Jun. 12, 2006, the disclosure of which is herein incorporated by reference in its entirety.

### BACKGROUND OF THE INVENTION

1. Field of the Invention

The invention relates generally to the mobile communication field. More specifically, the invention relates to systems and methods related to radio beam forming by a smart antenna.

2. Description of the Prior Art and Related Information

Since the introduction of cellular service in the early 1980's, the mobile communications networks have led to an increasing demand for enhancing efficiency and performance characteristics of the network. Increasing network capacity at peak usage hours, enhanced data rates for mobile data devices, signal quality, network coverage, and reduction in harmful interference to collocated wireless services are important considerations in building a network. In a wireless communication system, a mobile unit such as a cellular phone transmits and receives Radio Frequency (RF) signals to and from cell site base stations (BTS). Multiple users can share a common communication medium through technologies such as code division multiple access (CDMA), time division multiple access (TDMA), and global system for mobile communications (GSM). In a conventional CDMA network, a typical cell site utilizes a 3-sector coverage solution to improve coverage and quality of service. A sector is typically defined as a 120-degree coverage area surrounding a cell node. In practice, when cell site sectorization has been implemented, the signal-to-interference ratio limits the service availability. This is still better than an omni-cell site (360 degree coverage with a single antenna), which is limited by the signal strength. For example, a 3-sector cell site can handle 48 to 50 users, as compared to only 25 users for a typical omni-cell site. A 6-sector solution improves capacity even further, but at a substantially higher cost.

To provide effective sector coverage without incurring the 6-sector expense, a smart antenna (SA), e.g., a beam steerable array system, may be employed. The SA can dynamically adjust the radiation beam based on call traffic patterns, thus providing improved signal quality, user capacity, and enhanced overall coverage area. A conventional SA system provides these advantages over conventional designs by providing RF energy through beam forming to a designated area of a sector, while reducing coverage in other parts of the same sector. This coverage shift occurs due to RF beam forming, which does not allow for uniform pilot sector coverage. Non-uniform pilot sector coverage typically results in hard hand offs and cell blockage. Providing a focused beam toward a selected zone within a coverage area can improve signal coverage without significantly decreasing overall coverage. A secondary advantage of an SA system is reduced transmitter power requirement for producing the desired coverage. The latter advantage is particularly useful for integrated transceiver—antenna modules where small size, low weight, and low power dissipation are required by operating conditions.

Implementation of an SA array requires a system alignment process to accurately form a controlled radiation beam. Such an alignment process is necessary to determine phase, amplitude and delay differences between each radiating element within the SA array. Uncompensated differences in phase, amplitude and delays between each transceiver—antenna module will lead to degraded SA performance. Previous attempts to solve the alignment problem involve factory calibration, and measurement of phase, amplitude and delay (calibration factors) responses at the time of manufacture. However, such an approach cannot avoid long-term degradation due to component drift and aging.

One conventional approach in determining calibration factors involves a remote calibration node assisted method. This approach requires the assistance from a remote subscriber/transponder unit from a predetermined location to accurately measure phase and amplitude differences for each transceiver. Typically, this approach requires that the remote node be in a clear line of sight (LOS) from an SA array system. In urban environments, finding such a clear LOS location can be very difficult. In addition, this approach requires a generation of N orthogonal test calibration signals be transmitted from each transceiver, where N is the number of transceiver—antenna modules within the SA array.

Another conventional calibration method utilizes a dedicated onsite calibration unit, for example, a dedicated transceiver co-located within the SA array and adapted for calibration measurements. For this calibration method, the calibration unit is placed into a test signal generation mode. The generated test signals are injected into respective transmitter and receiver chains within the SA array. The receiver section within the calibration unit is used to compute the phases and amplitude responses of multiple calibration signals.

As described above, both conventional methods require auxiliary equipments and external test signal generation, and require down time from normal revenue operation. In addition, specialized calibration equipments are needed for phase and amplitude test signal determination.

Therefore, a need exists for an SA array that avoids the limitations of the above-mentioned calibration methods while providing the capability for omnipresent calibration that does not burden the SA array with expensive calibration equipment.

### SUMMARY OF THE INVENTION

In view of the foregoing, the following system and methods provide improved performance and signal quality for wireless communications systems with smart antenna arrays.

In a first aspect, the present invention provides a smart antenna system including a plurality of antennas, a plurality of Transmit—Receive Modules (TRMs) coupled respectively to the plurality of antennas, and a beam steering module coupled to the plurality of TRMs and providing radiation beam steering for the plurality of TRMs. The beam steering module includes a pilot generator for generating a pilot signal and providing it to the TRMs to calibrate a receive (RX) reference plane.

In a preferred embodiment, the pilot signal may be a CDMA signal with a unique pilot code. Each TRM may include a first signal sampling coupler for injecting the pilot signal into an RX path in the TRM, and a second signal sampling coupler for sampling a feedback pilot signal and providing it to the beam steering module. The TRM may further include a demodulator. The second signal sampling coupler is preferably located before the demodulator in the RX path. The second signal sampling coupler may include a demodulated-data diverter connected to an output of the demodulator in the RX path.

The TRM may further include a duplexer, a receiver section, and an I/Q modulator in the RX path between the first signal sampling coupler and the second signal sampling coupler. The feedback pilot signal carries one or more of phase, amplitude, and delay information of the RX path. The beam steering module may further include a master controller for calibrating the RX reference plane, an in-phase aggregator for summing a plurality of feedback pilot signals from the plurality of TRMs, and a received signal strength indication (RSSI) processor for receiving the summed feedback pilot signal from the in-phase aggregator and for outputting a signal indicative of a difference among the plurality of feedback pilot signals to the master controller. The master controller is configured to adjust a phase of the l/Q modulator for calibrating the RX reference plane.

In a preferred embodiment, the beam steering module further includes a signal circulator for isolating the generated pilot signal and directing the pilot signal, and a signal divider/combining network dividing the generated pilot signal and sending the divided pilot signals to the plurality of TRMs. The signal divider/combining network is adapted to divide the generated pilot signal into N pilot signals, and to send each of the N divided pilot signals to a corresponding TRM among a total number of N TRMs.

In a preferred embodiment, the beam steering module includes a fiber optic backplane (FOB). The FOB is coupled to a base station via a fiber optic interface.

According to another aspect, the present invention provides a smart antenna system including a plurality of antennas, a plurality of Transmit—Receive Modules (TRMs) coupled respectively to the plurality of antennas, and a beam steering module coupled to the plurality of TRMs and providing radiation beam steering for the plurality of TRMs. Each TRM includes a data port, a modulator adapted for receiving a CDMA signal having a pilot from a base station and providing a modulated RF signal, and an amplifier. The amplifier is configured to amplify the CDMA signal before outputting the amplified CDMA signal to a corresponding antenna. The beam steering module is configured for receiving sampled output signals from the plurality of TRMs and for calibrating a transmit (TX) reference plane based on a detected pilot signal therein.

In a preferred embodiment, each TRM further includes a signal coupler for sampling the output signal and providing the sampled output signal to the beam steering module. The signal coupler may also be adapted to inject a pilot signal generated within the beam steering module into the TRM to calibrate a receive (RX) reference plane.

In a preferred embodiment, he sampled output signal carries one or more of phase, amplitude, and delay information of a TX path.

The beam steering module may further include a rake receiver for receiving a combined signal from the signal divider/combining network, and a master controller for calibrating the TX reference plane based on an output of the rake receiver. The beam steering module may further include means for cross correlating the plurality of sampled output signals from the plurality of TRMs.

In a preferred embodiment, the smart antenna system further includes a signal divider/combining network for combining a plurality of sampled output signals from the plurality of TRMs. The signal divider/combining network is also part of a receive (RX) reference plane calibration signal path. The master controller may also be adapted to calibrate the RX reference plane.

Each TRM preferably further includes means for selecting prescribed pseudo noise (PN) spreading codes.

The beam steering module preferably includes a fiber optic backplane (FOB). The FOB is coupled to a base station via a fiber optic interface.

According to another aspect, the present invention provides a method for calibrating a smart antenna system having a plurality of antennas each coupled to a receive (RX) path including a receiver section. The method includes injecting a pilot signal at a first location before the receiver section into the RX path, sampling the pilot signal at a second location after the receiver section, and calibrating an RX reference plane based on the sampled pilot signal.

In a preferred embodiment, calibrating the RX reference plane further includes applying a pilot cancellation technique on the sampled pilot signal. Applying the pilot cancellation technique on the pilot signal may include adjusting a phase of the pilot signal.

The method may also include calibrating a transmit (TX) reference plane, by sampling a transmit signal in a TX path at the first location. The transmit signal may comprise an existing transmit signal to be sent to a user terminal equipment (UTE).

Calibrating the TX reference plane preferably further includes summing a plurality of sampled transmit signals corresponding to the plurality of antennas using a signal divider/combining network. Calibrating the RX reference plane may also use the same signal divider/combining network for dividing the pilot signal.

Calibrating the TX reference plane preferably further includes selecting prescribed pseudo noise (PN) spreading codes for the transmit signal to be sampled, and cross correlating the plurality of sampled transmit signals. Calibrating the TX reference plane may further include adjusting a phase of the transmit signal using a master controller. The phase of the pilot signal may be adjusted using the same master controller for calibrating the RX reference plane.

According to another aspect, the present invention provides a method for calibrating a smart antenna system having a plurality of antennas each coupled to a transmit (TX) path including a transmitter section. The method includes sampling a transmit signal having a pilot signal component from each of the TX paths at a first location in the TX path after the transmitter section, and calibrating a TX reference plane based on the sampled transmit signal.

In a preferred embodiment, calibrating the TX reference plane further includes selecting prescribed pseudo noise (PN) spreading codes for the transmit signal to be sampled, and cross correlating the plurality of sampled transmit signals to extract the pilot signal.

The method may further include calibrating an RX reference plane by injecting a test signal to an RX path at the first location. The sampled transmit signals may be summed using a divider/combining network, and the test signal may be divided into a plurality of test signals using the same divider/combining network. A master controller is used to adjust a phase of the test signal using a master controller, and to adjust a phase of the transmit signal using the master controller.

According to another aspect, the present invention provides a communication system, including a base station, a fiber optic communication link, and a smart antenna system coupled to the base station via the fiber optic communication link. The smart antenna system includes a plurality of Transmit—Receive Modules (TRMs), and a fiber optic backplane (FOB) coupled to fiber optic communication link and to the plurality of TRMs through a second interface and providing radiation beam steering for the plurality of TRMs. The FOB includes a pilot generator for generating a test signal to calibrate a receive (RX) reference plane. A transmit signal in each of the plurality of TRMs is sampled for calibrating a transmit (TX) reference plane.

In a preferred embodiment, each TRM includes a coupler at a first location in an RX path for injecting the test signal from the FOB into the RX path in the TRM. The coupler is also adapted for sampling the transmit signal from a TX path in the TRM into the FOB. The FOB may further include a master controller for calibrating both the RX reference plane and the TX reference plane.

The FOB preferably further includes a signal divider/combining network for combining a plurality of transmit signals from the plurality of TRMs sampled into the FOB from the coupler, and for dividing the test signal and sending the divided test signal to the plurality of TRMs through the coupler.

Further aspects of the construction and method of operation of the invention, with additional objects and advantages thereof, will be best understood from the following description of specific embodiments when read in connection with the accompanying drawings.

### BRIEF DESCRIPTION OF THE DRAWINGS

FIG. 1 is a block schematic drawing of a smart antenna system in accordance with an embodiment of the present invention.

FIG. 2 shows a main beam array pattern tilt angle relative to the bore sight of the smart antenna.

FIGS. 3A and 3B present top level details of a transmit—receive module.

FIGS. 4A and 4B present top level details of the fiber optic backplane and interconnections with the rest of the array.

FIG. 5A presents a code-domain representation for an IS-97 CDMA type signal.

FIG. 5B presents a phase and amplitude vector diagram resulting in a minimized, transmitted signal from the smart antenna array.

FIG. 6 presents details of the RF signal combiner module used for receive path pilot cancellation.

### DETAILED DESCRIPTION

The present invention will now be described, by way of example, the best mode contemplated by the inventors for carrying out the present invention, in reference with the accompanying drawings. It shall be understood that the following description, together with numerous specific details, may not contain specific details that have been omitted as it shall be understood that numerous variations are possible and thus will be detracting from the full understanding of the present invention. It will be apparent, however, to those skilled in the art, that the present invention may be put into practice while utilizing various techniques.

Disclosed herewith is a smart antenna system and method for calibrating a smart antenna array having a plurality of Transmit—Receive Modules (TRMs). (As used herein a Transmit—Receive Module, or TRM, includes at least a transmit or a receive path but may preferably include both.) In accordance with a preferred embodiment of the present invention, a smart antenna system comprises a plurality of TRM-integrated antennas, a beam steering module (e.g., a backplane), and a suitably coupled interface. Although a fiber optic backplane (FOB) and a fiber optic interface are preferred and are referred to herein, the invention is not so limited and a coaxial or other coupling to the BTS may be employed.

TRMs co-operating with a fiber optic backplane (FOB) are combined into a receiving/transmitting array adapted for receiving multichannel/multicarrier uplink (UL) CDMA signals from user terminal equipment (UTE) and transmitting multichannel/multicarrier downlink (DL) CDMA signals towards UTE's. The TRMs employ an interface that provides power supply lines and control lines for the module operation. Each TRM incorporates a first signal sampling coupler for providing a sampled output from TRM transmitted (TX) DL signal.

In addition to TX sampling, the first signal sampling coupler is also used for injecting a receive (RX) path pilot signal between the antenna and a common port of a duplexer interface. A second signal sampling coupler is used to sample the received signal, just before a demodulator. The receive path pilot signal is delivered to an injection port from a 1:N signal power divider network coupled from an isolator. The isolator provides both isolation and signal direction to the pilot signal supplied by the pilot signal source.

For TX path (DL), a CDMA pilot signal code domain cancellation scheme, similar to discrete RF pilot cancellation scheme may be employed. This advantageously utilizes existing pilot channels for the purposes of calibrating an SA system. In a CDMA modulated carrier signal each user is assigned a unique (Walsh) code which is carried by the user's signal. The orthogonality of these codes allows the base station and mobile unit(s) to distinguish the each other's signals from all other signals within the received spectrum. In IS-97 standard (as well as other CDMA based standards) used extensively in PCS-1900 service, a dedicated Walsh code, e.g., code 0 for a pilot signal, is used to assist UTE's acquiring synchronization establishing downlink between BTS and UTE. Typically the power of the pilot signal (in code domain) is greater than that of any other channels. A high power pilot signal allows UTE to achieve quick synchronization with the pilot signal of the transmitting BTS by performing cross correlation search between the received signal (from BTS) and the locally generated pilot. A similar cross-correlation method is adapted to attain downlink path calibration by providing TX RF sample from each TRM and routing to a dedicated rake receiver for relative phase and amplitude determination.

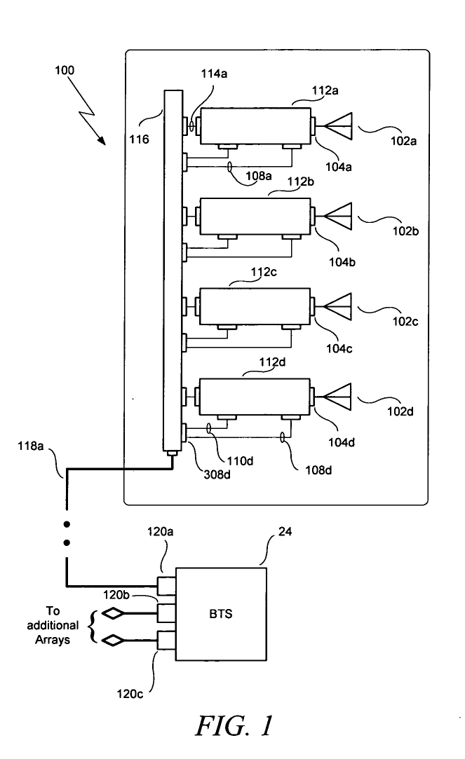

A preferred embodiment of the invention is now described with reference to FIGS. 1-6. Referring to FIG. 1, an SA 100 and associated BTS 24 terminal equipment are shown. An exemplary SA 100 comprises a plurality of TRMs 112a-112d with integrated receive/transmit antennas 102a-102d. Even though the present example depicts four such TRMs, it is not by any way to limit the present invention, and it shall be understood that any suitable number of TRMs can be used for constructing an SA 100.

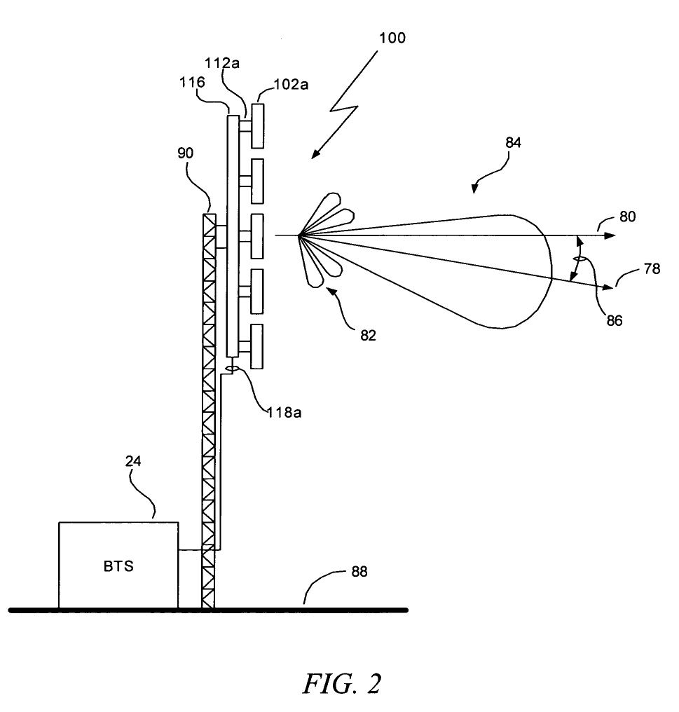

The TRMs employ an interface that provides power supply lines and control lines for the module operation. FIG. 2 details four TRMs 112a-112d vertically aligned along the tower 90. Vertical orientation is chosen for ease of graphical representation only, and other orientations can be used. Such an exemplary graphical representation is only used for facilitating understanding of the present invention.

As seen in FIG. 2, the main beam direction 78 has a tilt angle 86 relative to an axial direction 80 of the SA 100. The axial direction 80 shown in this exemplary configuration is substantially horizontal, and is substantially parallel to the terrain 88. It is noted that embodiments of the present invention can be used for both tilt angle or azimuth beam steering applications. Furthermore, a combination of tilt and azimuth steering can be attained when a 2×2 or 4×4 TRM array is deployed.

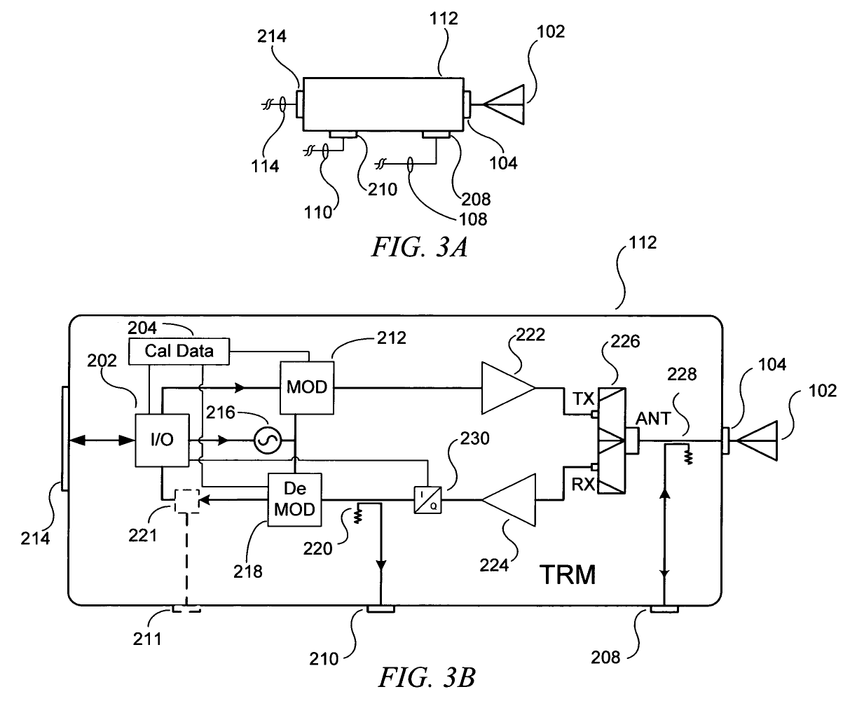

As shown in FIG. 2, the TRMs 112a-112d are mechanically and electrically connected with FOB 116. Referring further to FIGS. 3A and 3B, each TRM incorporates an integrated receive/transmit antenna 102 coupled to a suitable duplexer 104 integrated into the TRM. TRMs 112a-112d employ a number of interfaces (108, 110, and 114) used for interfacing between FOB 116 and TRMs 112a-112d. In FIG. 1 these interfaces are shown as individual data—signal—power lines, but it shall be understood that an actual implementation may employ alternative implementations, as it is well known to the one skilled in the art.

As shown in FIGS. 1 and 2, FOB 116 incorporates a composite fiber optic—power feed line 118a interface to BTS 24 via BTS fiber optic interface 120a. The BTS supplies required power to the SA 100. The SA 100 is preferably remotely mounted on top of a suitable tower 90 or other elevatory means in order to provide desired signal coverage. Fiber optic interface line 118a can utilize several well known transport means such as RF-over-Fiber or Digital-RF-over-fiber techniques known to those skilled in the art. In addition, an industry standard communication protocol, such as Common Packet Radio Interface (CPRI), can be implemented and used to maintain operation between BTS 24 and FOB 116. Details concerning such implementation should be considered by those skilled in the art as within the scope of this disclosure.

Each TRM incorporates a first signal sampling coupler for providing a sampled output from TRM transmitted DL signal. In addition to TX sampling, the first signal sampling coupler is also used for injecting a receive path pilot signal between the antenna and a common port of a duplexer interface.

FIGS. 3A and 3B are block diagrams illustrating several functional and interconnection details of a TRM 112. TRM 112 is integrated with transmit-receive antenna 102 that are connected via antenna interface 104 to the TRM 112 exterior enclosure. RF signals to and from transmit-receive antenna 102 are sampled by a first signal sampling coupler 228 disposed between antenna 102 and duplexer 226 antenna port.

A sample port of the first signal coupler 228 is coupled to the first sample port 208 connection. Sample port 208 connection is coupled via signal path 108 to the corresponding port, e.g., 308d, of the FOB 116. Duplexer 226 is of conventional design and intended to provide isolation between transmitter section 222 and receiver section 224. Although transmitter section 222 and receiver section 224 are shown schematically as triangles and indicating an amplification stage, they may employ numerous design implementations to achieve desired performance parameters as known to those skilled in the art.

A second signal sampling coupler is used to sample the received signal, just before a demodulator. The receiver section 224 output is coupled to an input of the Demodulator 218 through the second coupler, e.g., a directional coupler 220. A coupled port of the coupler 220 is coupled to the interface 210 connection. Interface 210 is coupled via signal path 110 to the corresponding port 308 of the FOB 116.

The Demodulator 218 output is coupled to I/O controller 202. 1/O controller 202 may be implemented to be in communication with FOB 116 via a suitable interface 214, while providing receiving and transmitting communications means to a demodulator 218 and modulator 212. Modulator 212 is used to up-convert composite downlink signals to suitable RF carrier signals. An output of Modulator 212 is coupled to transmitter section 222 for a suitable amplification and frequency conversion (not shown).

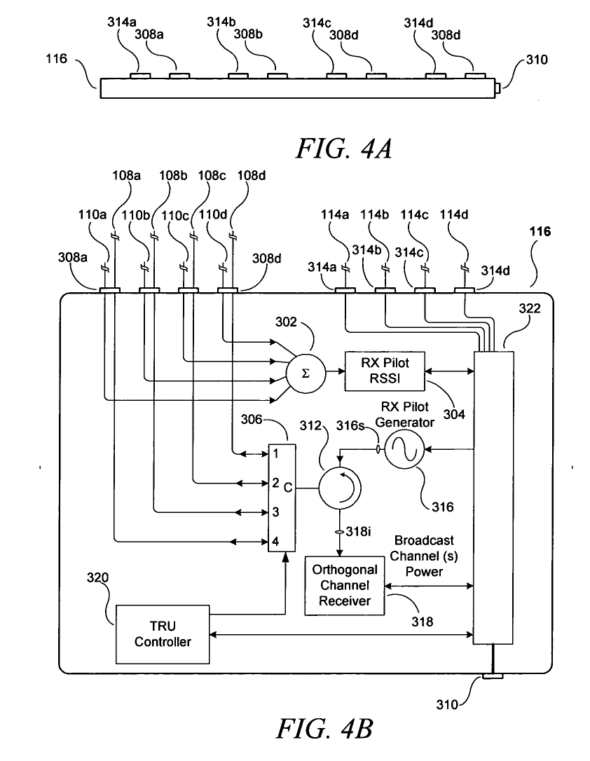

FIGS. 4A and 4B depict top and detailed views, respectively, of level block diagrams for the FOB 116. The basic function for FOB 116 is to provide signal distribution to and from TRMs 112a-112d, and wave front calibration means for the overall SA 100 system, so as to provide radiation beam steering.

FIG. 4A depicts a top level view of FOB 116 together with required interconnection ports (308a-308d, 310, 314a-314d). TRM data ports 314a-314d and composite ports 308a-308d are adapted to provide required signal flow to and from TRMs 112a-112d (shown together in FIG. 1). Module to backplane interconnection may require a use of suitable combination blind mate connectorization technology and other interconnect solutions known in the art. In addition to being an electrical signal router and controller, FOB 116 can be implemented as a frame carrier for TRMs 112a-112d so as to provide mechanical housing means for the TRMs.

Referring to FIG. 4B, which is a detailed block diagram for FOB 116, a main BTS to FOB port 310 provides interconnection to the BTS 24 extender port 120 (not shown). A master controller 322 receives DL and transmits UL transmission signals from/to BTS 24 via a suitable fiber optic interconnection 118 medium. In addition to UL/DL RF signals required for cell cite traffic operations, FOB 116 provides operational control information to the BTS 24. For DL path RF signals, FOB 116 routes them to each active TRMs 112a-112d. For UL path RF signals, FOB 116 receives and routes UL signals from each of the TRM interfaces 314a-314d. Master controller 322 is configured to provide functional and logic means to each TRM to perform and maintain reference signal plane calibration.

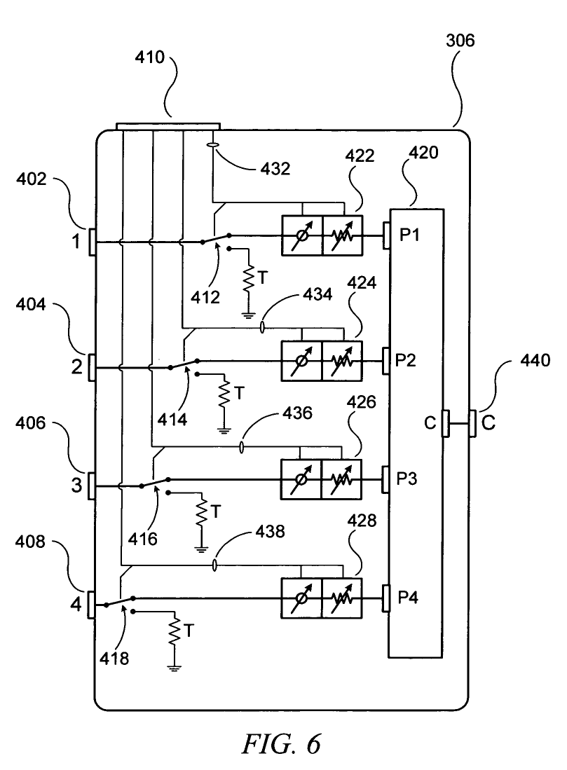

FIG. 6 provides additional details of network 306 used for establishing and maintaining reference signal plane for both UL and DL RF signal direction. Network 306 is common for both TX and RX reference plane calibration paths. As a result of this configuration, DL beam steering and UL reception steering are simultaneously possible by adjusting relative phase of each phase/amplitude controllers (422, 424, 426 and 428) within network 306. In case of a TRM failure, SA can be recalibrated to operate in a ‘limp’ mode by re-adjusting phase phase/amplitude. For example, in the case of 3 modules, a 120 degree difference is required for reference signal plane calibration. TRU module controller 320 can determine which of the TRMs are still functional, and adjust signals (432, 434, 436, and 438) using phase phase/amplitude controllers (422, 424, 426 and 428) to achieve RX and TX pilot cancellation. A failed TRM is removed by disabling the appropriate switches (412, 414, 416, and 418) so as not to affect operation.

Establishment of a known reference signal plane (or wave front) at the antenna 102 requires precise knowledge of phase, amplitude and delay characteristics of the signal path between the input port and combining port. One way to achieve a reference signal plane is to inject a known test (pilot) signal and perform a network analysis between the input and output signals, and to compute differences between each TRM. Signal minimization through destructive signal combining has been commonly used in Feed Forward Power Amplifiers (FFPA) to attain Inter-Modulation Distortion (IMD) signal cancellation by amplifying and phase-inverting corresponding error signal. An error path test (pilot) signal based control system has been successfully used to attain high degree of cancellation of IMD products in the output of the FFPA system. A similar test (pilot) signal controlled cancellation technique can be used to attain a high degree of phase and amplitude alignment in SA.

The present invention preferably utilizes a pilot cancellation technique to facilitate reference plane calibration. Such techniques have been described in, for example, U.S. Pat. No. 5,796,304, issued Aug. 18, 1998 entitled “Broadband Amplifier with Quadrature Pilot Signal”; U.S. Pat. No. 6,169,450, issued Jan. 1, 2001 entitled “Feed Forward Compensation Using Phase and Time Modulation;” and U.S. patent application Ser. No. 10/818,546 filed Apr. 5, 2004 entitled “Multi-transmitter Communication System Employing Anti-Phase Pilot Signals,” now U.S. Pat. No. 7,110,739 issued Sep. 19, 2006. These patents and patent applications are assigned to the assignee of the present application, and their disclosures are incorporated herein by reference in their entirety.

In one aspect, the present invention is directed to establishing calibrated phase and amplitude reference planes for both transmit (TX) and receive (RX) paths.

For calibrating an uplink wavefront based on calibration pilot signal reception, a receive path test signal is delivered to an injection port from a 1:N signal power divider network coupled from a signal circulator. The circulator provides both isolation and signal direction to the test signal supplied by a pilot signal source. For TX path (DL), a CDMA pilot signal code domain cancellation scheme, similar to discrete RF pilot cancellation schemes, may be employed.

As shown in FIG. 4B, to establish a reference plane as close as possible to the antenna 102, an RX pilot generator 316 is used to generate CDMA test signal 316s, which is coupled to a first port of the signal circulator 312. A second port of the signal circulator 312 is coupled to common signal port 440 of the divider/combining network 306. FIG. 6 shows further details of the network 306. As shown, the input-output ports (402, 404, 406, and 408) of the network 306 are coupled to the first port of the TRM interface 308a-308d seen in FIG. 4B.

In accordance with an embodiment of the invention, a 4-way network with equal amplitude division while providing 90 degree phase difference between adjacent ports is employed. Table 1 as shown below provides a summary of amplitude and phase relationships for such network:

TABLE 1
Amplitude and phase relationships for a network in accordance
with an embodiment of the invention.

| Port | Amplitude | Phase |
|---|---|---|
| P1 | A/4 | 0 |
| P2 | A/4 | 90 |
| P3 | A/4 | 180 |
| P4 | A/4 | 270 |

Table 1 refers to amplitude of the signal at the common port 440 (assuming that all phase/amplitude adjusters are kept at nominal settings). Similarly, a four-port network is only one example and not a limiting factor, as an N-port network may be implemented if N TRMs are used.

Test signal 316s is coupled via interconnection paths 108a-108d into TRMs' first sample port 208. Referring back to FIG. 3B, test signal 316s is injected between antenna 102 and duplexer 226 within each of the TRMs 112a-112d, through a suitably-constructed directional coupler 228.

Upon injection into the RX path of each of the TRMs 112a-112d, test signal 316s is passed through a duplexer 226 onward into the receiver section 224, through l/Q modulator 230 before being sampled by suitably constructed coupler 220 disposed at the input of the de-modulator 218.

Coupled port of the coupler 220 contains UL RF signals as well as test signal 316s, which are fed into RF interface 210. From interface 210, sampled test signal 316s, together with UL signals, are fed through interconnections 110a-110d back into the second port of the TRM interface 308a-308d. From the second port of the TRM interface 308a-308d, UL composite RF signals are coupled into the pilot signal in-phase aggregator 302, as shown in FIG. 4B.

Pilot signal in-phase aggregator 302 separates test signal 316s from each composite UL RF signals received from individual TRM interfaces 308a-308d, while summing each isolated test signals 316s together in phase. This can be implemented using numerous receiver techniques as well known to one skilled in the art. The summed test signal output from in-phase aggregator 302 is sent into RX Pilot RSSI processor 304. RX Pilot RSSI processor 304 may provide a digital or analog signal indicative of the combined total of all received test signals 316s to master controller 322. Test (pilot) signal minimization as determined by processor 304 can be used to achieve signal minimization to establish reference phase between each TRM DL paths, by adjusting phase (assuming that amplitude levels are the same) for the test (pilot) signal.

Coupler 220 may be replaced by a demodulated data diverter 221, shown as an optional component in FIG. 3B. Demodulated data diverter 221 sends received pilot baseband-related data to a TRM data port 211. From TRM data port 211, pilot data is transferred to aggregator 302 adapted to operate with pilot signals at baseband. Numerous signal processing techniques can be adapted to operate with pilot signals at baseband in order to establish an RX reference plane. Additional signal processing costs are offset by inherent de-modulator 218 in path calibration.

For either implementation, master controller 322 can periodically verify cancellation of pilot signals in order to maintain the RX reference plane.

As shown in FIG. 4B, the output of the RX Pilot Generator 316 is controlled by master controller 322, which determines operational frequency of test signal 316s based on predetermined criteria facilitating calibration of UL path, i.e., the RX path, reference plane.

In one aspect, the present invention is directed to establishment of calibrated phase and amplitude reference planes for both transmit (TX) and receive (RX) paths.

Reference plane determination for the DL path is somewhat different from that of the UL path. In accordance with an embodiment of the invention, a cross-correlation method, similar to that used in the UTE to achieve synchronization with the pilot signal of the transmitting BTS, is adapted to attain DL path calibration by providing TX RF sample from each TRM and routing to a dedicated rake receiver for relative phase and amplitude determination. A downlink wavefront can be calibrated based on Walsh-code cross correlated signal reception. Thus, existing signals in the TX path can be utilized as pilot signals without a need for a separate TX pilot generator as the RX pilot generate 316.

In a CDMA-modulated carrier signal, each user is assigned a unique (Walsh) code carried by the user's signal. The orthogonality of these codes allows the base station and mobile unit(s) to distinguish each other's signals from all other signals within the received spectrum. In IS-97 and other CDMA-based standards, a dedicated Walsh code, for example, code 0, is employed for a pilot signal used to assist user terminal equipment (UTE) in acquiring synchronization, establishing downlink (DL) between the BTS and the UTE.

The power of the pilot signal (in code domain) is typically greater than that of any other channel. A high power pilot signal allows the UTE to achieve quick synchronization with the pilot signal of the transmitting BTS by performing a cross-correlation search between the received signal (from BTS) and the locally generated pilot.

In an SA system, a pilot signal is transmitted and used by a User UTE to determine if a suitable downlink channel is available. A conventional UTE cannot accurately determine a pilot signal's arriving direction. Received signal strength indication (RSSI) and pilot signal code-domain power are the only means available to UTE, which cross-correlates the received signal with the appropriate spreading codes, thus extracting a pilot signal from the received beam, to estimate the DL signal path.

Referring back to FIG. 3B, TRM 112 TX (or DL) path reference plane calibration can be implemented using modulator 212, and further by selecting prescribed pseudo noise (PN) spreading codes for pilot signal generation. Output of the modulator 212 is processed and amplified by TX path 222 circuits the output of which is coupled to a TX port of the TRM 112 duplexer 226. ANT port of the duplexer 226 is coupled through directional coupler 228 to antenna interface 104 onward to antenna 102. Sampled TX signals will appear at the first signal sampling port 208.

Referring back to FIG. 4B, the sampled TX signals from all available TRMs 112a-112d will now traverse from first sample ports 208a-208d through interconnects 108a-108d pass into first TRM interface 308a-308d, and terminate at output terminals 306-1-306-4 of the 1:4 divider/combining network 306. In this application, the 1:4 divider/summing network acts as a signal summing network. The summed signal will appear at input 306-c terminal, which in this mode operates as an output. Common terminal 306-c terminal is coupled to a second port of circulator 312 so that a composite TX signal appears at the port 3 of circulator 312. Port 3 of circulator 312 is coupled to orthogonal channel receiver (rake receiver) 318, the output of which is coupled to master controller 322. Transceiver unit (TRU) controller 320 provides supervisory functions for each TRU interface.

To establish a DL reference wavefront, each TRM operates to transmit a calibration CDMA wave form. In a typical IS-97 system, the following CDMA signal configuration may be used:

TABLE 2
Nominal Downlink Testing Model (for IS-97).

| Code | # | Relative | |
|---|---|---|---|
| Type | Channels | Power (dB) | Comments |
| Pilot | 1 | −7.0 | Code channel 0 |
| Sync | 1 | −13.3 | Code channel 32, always ⅛ |
| | | | rate |
| Paging | 1 | −7.3 | Code channel 1, full rate only |
| Traffic | 1-6 | −10.3 | Variable code channel |
| | | | assignments; full rate only |

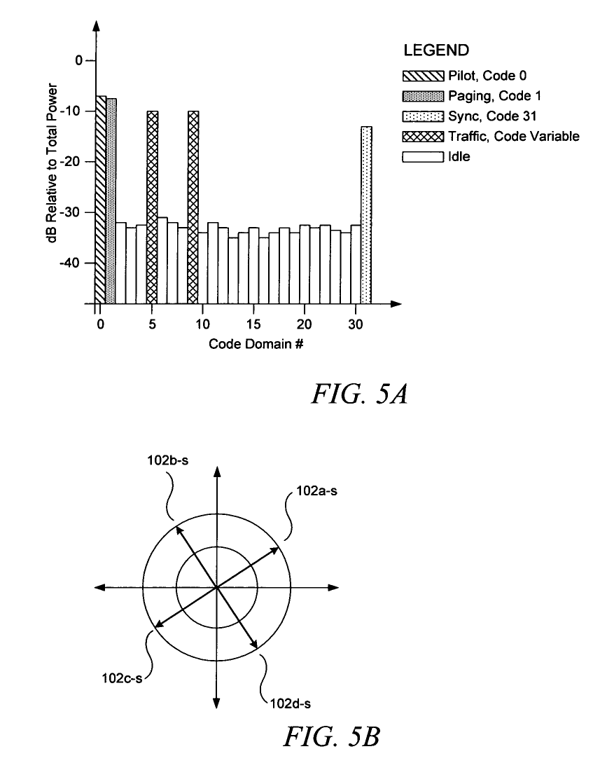

A code domain graph is presented in FIG. 5A showing Pilot, Sync, Paging and two Traffic Channels. The two traffic channels have been assigned codes 5 and 9, respectively.

Since BTS 24 is supplying CDMA signal information to the master controller 322, all of the information in Table 2 is available to rake receiver 318. Input to rake receiver 318 is a summation of the TRM 112a-112d downlinks. Each TRM can be commanded by master controller 322 to turn on/off its downlink output and to adjust relative phase and amplitude of its output signal. Consequently, a calibration procedure starts with master controller 322 turning on and off each TRM 112a-112d, to establish and adjust reference signal amplitude contributed by each module. Upon establishment of reference amplitude 318i, master controller 322 enables all TRM 112a-112d to transmit in DL mode, while adjusting relative phase of a traffic signal in modulator 212 and in each TRM 112a-112d, to achieve maximum pilot signal while minimizing a selected traffic channel, as measured by rake receiver 318.

A minimum code domain level is achieved when relative phase of each traffic channel is at 90 degrees with respect to each other as shown in FIG. 5B. The calibration process can follow numerous minimization techniques.

Initial phase and amplitude characteristics for each modulator 212 may be determined during the manufacturing process, and stored into each TRM calibration storage memory 204. Thus, the stored initial phase and amplitude characteristics are available to master controller 322 for initial phase cancellation setting. Once cancellation has been achieved, each modulator 212 can be commanded to align phase to achieve desired radiation pattern shift, since the downlink reference plane relationship between all TRMs has been determined.

As discussed earlier, reference plane determination for the uplink path is somewhat different from that for the downlink path. In order to establish a reference plane as close as possible to the antenna 102, a RX Pilot generator 316 is used to generate test CDMA 316s signal, which is injected between antenna 102 and duplexer 226 within each of the TRMs 112a-d. As described earlier, test CDMA signal 316s may be demodulated by each TRM demodulators 218 before being fed back into FOB 116 pilot signal summing network 302 before being fed into RX Pilot Receiver 304. Pilot signal minimization as determined by RX Pilot Receiver 304 can be used to achieve similar signal minimization technique in order to establish reference phase between each TRM downlink paths by adjusting phase (assuming that amplitude levels are the same) for the demodulated pilot signal.

Despite of the differences in the RX and the TX reference plane calibration, the signal combining network 306 shown in FIG. 6 can be advantageously used by both the RX and the TX reference plane calibration signal paths. In addition, the master controller 322 in the FOB is used to control the calibration of both the RX and TX reference planes.

The present invention has been described in relation to a presently preferred embodiment, however, it will be appreciated by those skilled in the art that a variety of modifications, too numerous to describe, may be made while remaining within the scope of the present invention. Accordingly, the above detailed description should be viewed as illustrative only and not limiting in nature.

What is claimed is:

1. A smart antenna system, comprising:
a plurality of antennas;
a plurality of Transmit—Receive Modules (TRMs) coupled respectively to the plurality of antennas; and
a beam steering module coupled to the plurality of TRMs and providing radiation beam steering for the plurality of TRMs, wherein the beam steering module comprises a pilot generator for generating a pilot signal and providing it to the TRMs to calibrate a receive (RX) reference plane.

2. A smart antenna system as set out in claim 1, wherein the pilot signal is a CDMA signal with a unique pilot code.

3. A smart antenna system as set out in claim 1, wherein each TRM comprises:
a first signal sampling coupler for injecting the pilot signal into an RX path in the TRM; and
a second signal sampling coupler for sampling a feedback pilot signal and providing it to the beam steering module.

4. A smart antenna system as set out in claim 3, wherein each TRM further comprises a demodulator, and wherein the second signal sampling coupler is located before the demodulator in the RX path.

5. A smart antenna system as set out in claim 3, wherein each TRM further comprises a demodulator, and wherein the second signal sampling coupler comprises a demodulated-data diverter connected to an output of the demodulator in the RX path.

6. A smart antenna system as set out in claim 3, wherein each TRM further comprises:
a duplexer;
a receiver section; and
an I/Q modulator in the RX path between the first signal sampling coupler and the second signal sampling coupler,
wherein the feedback pilot signal carries one or more of phase, amplitude, and delay information of the RX path.

7. A smart antenna system as set out in claim 6, wherein the beam steering module further comprises:
a master controller for calibrating the RX reference plane;
an in-phase aggregator for summing a plurality of feedback pilot signals from the plurality of TRMs; and
a received signal strength indication (RSSI) processor for receiving the summed feedback pilot signal from the in-phase aggregator and for outputting a signal indicative of a difference among the plurality of feedback pilot signals to the master controller.

8. A smart antenna system as set out in claim 7, wherein the master controller is configured to adjust a phase of the I/Q modulator for calibrating the RX reference plane.

9. A smart antenna system as set out in claim 1, wherein the beam steering module further comprises:
a signal circulator for isolating the generated pilot signal and directing the pilot signal; and
a signal divider/combining network dividing the generated pilot signal and sending the divided pilot signals to the plurality of TRMs.

10. A smart antenna system as set out in claim 9, wherein the signal divider/combining network is adapted to divide the generated pilot signal into N pilot signals, and to send each of the N divided pilot signals to a corresponding TRM among a total number of N TRMs.

11. A smart antenna system as set out in claim 1, wherein the beam steering module comprises a fiber optic backplane (FOB), and wherein the FOB is coupled to a base station via a fiber optic interface.

12. A smart antenna system, comprising:
a plurality of antennas;
a plurality of Transmit—Receive Modules (TRMs) coupled respectively to the plurality of antennas; and
a beam steering module coupled to the plurality of TRMs and providing radiation beam steering for the plurality of TRMs,
wherein each TRM comprises:
a data port;
a modulator adapted for receiving a CDMA signal having a pilot from a base station and providing a modulated RF signal; and
an amplifier,
wherein the amplifier is configured to amplify the CDMA signal before outputting the amplified CDMA signal to a corresponding antenna,
wherein the beam steering module is configured for receiving sampled output signals from the plurality of TRMs and for calibrating a transmit (TX) reference plane based on a detected pilot signal therein.

13. A smart antenna system as set out in claim 12, wherein each TRM further comprises a signal coupler for sampling the output signal and providing the sampled output signal to the beam steering module.

14. A smart antenna system as set out in claim 13, wherein the signal coupler is also adapted to inject a pilot signal generated within the beam steering module into the TRM to calibrate a receive (RX) reference plane.

15. A smart antenna system as set out in claim 13, wherein the sampled output signal carries one or more of phase, amplitude, and delay information of a TX path.

16. A smart antenna system as set out in claim 13, wherein the beam steering module further comprises:
a rake receiver for receiving a combined signal from the signal divider/combining network; and
a master controller for calibrating the TX reference plane based on an output of the rake receiver.

17. A smart antenna system as set out in claim 16, wherein the beam steering module further comprises means for cross correlating the plurality of sampled output signals from the plurality of TRMs.

18. A smart antenna system as set out in claim 16, further comprising:
a signal divider/combining network for combining a plurality of sampled output signals from the plurality of TRMs,
wherein the signal divider/combining network is also part of a receive (RX) reference plane calibration signal path.

19. A smart antenna system as set out in claim 18, wherein the master controller is also adapted to calibrate the RX reference plane.

20. A smart antenna system as set out in claim 12, wherein each TRM further comprises means for selecting prescribed pseudo noise (PN) spreading codes.

21. A smart antenna system as set out in claim 12, wherein the beam steering module comprises a fiber optic backplane (FOB), and wherein the FOB is coupled to a base station via a fiber optic interface.

22. A method for calibrating a smart antenna system having a plurality of antennas each coupled to a receive (RX) path including a receiver section, the method comprising:
injecting a pilot signal at a first location before the receiver section into the RX path;
sampling the pilot signal at a second location after the receiver section; and
calibrating an RX reference plane based on the sampled pilot signal.

23. A method as set out in claim 22, wherein calibrating the RX reference plane further comprises:
applying a pilot cancellation technique on the sampled pilot signal.

24. A method as set out in claim 23, wherein applying the pilot cancellation technique on the pilot signal comprises:
adjusting a phase of the pilot signal.

25. A method as set out in claim 22, further comprising:
calibrating a transmit (TX) reference plane.

26. A method as set out in claim 25, wherein:
calibrating the TX reference plane comprises sampling a transmit signal in a TX path at the first location.

27. A method as set out in claim 26, wherein:
sampling the transmit signal comprises sampling existing transmit signal to be sent to a user terminal equipment (UTE).

28. A method as set out in claim 26, wherein:
calibrating the TX reference plane further comprises summing a plurality of sampled transmit signals corresponding to the plurality of antennas using a signal divider/combining network.

29. A method as set out in claim 28, wherein calibrating the RX reference plane comprises dividing the pilot signal using the same signal divider/combining network.

30. A method as set out in claim 28, wherein calibrating the TX reference plane further comprises:
selecting prescribed pseudo noise (PN) spreading codes for the transmit signal to be sampled; and
cross correlating the plurality of sampled transmit signals.

31. A method as set out in claim 26, wherein calibrating the TX reference plane further comprises adjusting a phase of the transmit signal using a master controller.

32. A method as set out in claim 31, wherein calibrating the RX reference plane comprises adjusting a phase of the pilot signal using the same master controller.

33. A method for calibrating a smart antenna system having a plurality of antennas each coupled to a transmit (TX) path including a transmitter section, the method comprising:
sampling a transmit signal having a pilot signal component from each of the TX paths at a first location in the TX path after the transmitter section; and
calibrating a TX reference plane based on the sampled transmit signal.

34. A method as set out in claim 33, wherein calibrating the TX reference plane further comprises:
selecting prescribed pseudo noise (PN) spreading codes for the transmit signal to be sampled; and
cross correlating the plurality of sampled transmit signals to extract the pilot signal.

35. A method as set out in claim 33, further comprising:
calibrating an RX reference plane by injecting a test signal to an RX path at the first location.

36. A method as set out in claim 35, further comprising:
summing a plurality of the sampled transmit signals using a divider/combining network; and
dividing the test signal into a plurality of test signals using the divider/combining network.

37. A method as set out in claim 35, further comprising:
adjusting a phase of the test signal using a master controller; and
adjusting a phase of the transmit signal using the master controller.

38. A communication system, comprising:
a base station;
a fiber optic communication link; and
a smart antenna system coupled to the base station via the fiber optic communication link, the smart antenna system comprising:
a plurality of Transmit—Receive Modules (TRMs); and
a fiber optic backplane (FOB) coupled to fiber optic communication link and to the plurality of TRMs through a second interface and providing radiation beam steering for the plurality of TRMs,
wherein the FOB comprises a pilot generator for generating a test signal to calibrate a receive (RX) reference plane,
wherein a transmit signal in each of the plurality of TRMs is sampled for calibrating a transmit (TX) reference plane.

39. A communication system as set out in claim 38, wherein each TRM comprises a coupler at a first location in an RX path for injecting the test signal from the FOB into the RX path in the TRM, and wherein the coupler is also adapted for sampling the transmit signal from a TX path in the TRM into the FOB.

40. A communication system as set out in claim 39, wherein the FOB further comprises a master controller for calibrating both the RX reference plane and the TX reference plane.

41. A communication system as set out in claim 39, wherein the FOB further comprises a signal divider/combining network for combining a plurality of transmit signals from the plurality of TRMs sampled into the FOB from the coupler, and for dividing the test signal and sending the divided test signal to the plurality of TRMs through the coupler.
